(19) United States
(12) Patent Application Publication
(10) Pub. No.: US 2026/0300013 A1
(43) Pub. Date: Oct. 1, 2026

(54) METHOD, DEVICE, AND MEDIUM FOR SHARING RESOURCE

(71) Applicants: Beijing Zitiao Network Technology Co., Ltd., Haidian District, Beijing (CN); Lemon Inc., Grand Cayman (KY)

(72) Inventors: Shuhui YU, Beijing (CN); Kaicheng GU, Beijing (CN); Zhongtao HU, Sydney (AU); Jinyan WANG, Beijing (CN); Yan WANG, Sydney (AU)

(21) Appl. No.: 19/097,488

(22) Filed: Apr. 1, 2025

(51) Int. Cl. G06F 9/50

(52) U.S. Cl. CPC G06F 9/5027

(57) ABSTRACT

Embodiments of the present disclosure provide a method, device, and medium for sharing resources. The method comprises determining resource requests for a plurality of containers. And the method comprises determining resource limits for the plurality of containers. And the method further comprises sharing, based on the resource requests and the resource limits, the resources among at least a portion of the plurality of containers, wherein the at least a portion of the plurality of containers belongs to a same user. And the method further comprises isolating, based on the resource requests and the resource limits, resource sharing among at least another portion of the plurality of containers, wherein the at least another portion of the plurality of containers belongs to different users.

### BACKGROUND

In the field of resource management, a pod is the smallest deployable and manageable unit. A pod can contain one or more closely related containers that usually work together to implement an application or a set of related services. For example, a web application may consist of a main container running a web server and an auxiliary container responsible for log collection, which are encapsulated in the same pod. And managing multiple containerized applications (pods) on physical devices refers to the automatic deployment, scaling, and management of containerized applications on physical machines.

### SUMMARY

In a first aspect according to some embodiments of the present disclosure, a method for sharing resources is provided. The method comprises determining resource requests for a plurality of containers. And the method comprises determining resource limits for the plurality of containers. And the method further comprises sharing, based on the resource requests and the resource limits, the resources among at least a portion of the plurality of containers, wherein the at least a portion of the plurality of containers belongs to a same user. And the method further comprises isolating, based on the resource requests and the resource limits, resource sharing among at least another portion of the plurality of containers, wherein the at least another portion of the plurality of containers belongs to different users.

In a second aspect according to some embodiments of the present disclosure, an electronic device comprising a memory and a processor is provided. The memory is configured to store computer instructions which, when executed by the processor, cause the processor to determine resource requests for a plurality of containers. The instructions further cause the processor to determine resource limits for the plurality of containers. In addition, the instructions further cause the processor to share, based on the resource requests and the resource limits, the resources among at least a portion of the plurality of containers, wherein the at least a portion of the plurality of containers belongs to a same user. In addition, the instructions further cause the processor to isolate, based on the resource requests and the resource limits, resource sharing among at least another portion of the plurality of containers, wherein the at least another portion of the plurality of containers belongs to different users.

In a third aspect according to some embodiments of the present disclosure, a non-transitory computer-readable medium is provided. The medium comprises instructions stored thereon which, when executed by a processor, cause the processor to determine resource requests for a plurality of containers. The instructions further cause the processor to determine resource limits for the plurality of containers. In addition, the instructions further cause the processor to share, based on the resource requests and the resource limits, the resources among at least a portion of the plurality of containers, wherein the at least a portion of the plurality of containers belongs to a same user. In addition, the instructions further cause the processor to isolate, based on the resource requests and the resource limits, resource sharing among at least another portion of the plurality of containers, wherein the at least another portion of the plurality of containers belongs to different users.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows a schematic diagram of a device resource hierarchy structure according to one or more embodiments of the present disclosure;

FIG. 2 is a flow chart illustrating an example process of sharing resources according to some embodiments of the present disclosure;

FIG. 3 is a flow chart illustrating an example process of determining pod request/limit according to some embodiments of the present disclosure;

FIG. 4 is a flow chart illustrating an example process of determining request/limit of a user group according to some embodiments of the present disclosure;

FIG. 5 is a flow chart illustrating an example process of dynamically adjusting container allocation resources according to some embodiments of the present disclosure. ;

FIGS. 6A and 6B are schematic diagrams of dynamically adjusting container resource allocation in a scaling operation scenario according to some embodiments of the present disclosure;

FIG. 7 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

As mentioned above, managing pods on physical devices refers to the automatic deployment, scaling, and management of containerized applications on physical machines. In order to optimize resource utilization, resource allocation rules and management on physical devices face huge challenges.

On the one hand, there are problems with resource sharing for multiple containers. One or more embodiments of the present disclosure may provide a method, device or medium for sharing resource for the multiple containers. Alternatively, the multiple containers belong to the same business deployed on the same physical machine can share the requested resources. When there is redundancy in resources, the containers with higher resource requirements are allowed to occupy other unused resources within the same business deployed on the same physical machine.

On the other hand, there are problems with resource isolation. That is, pods of different businesses need to be deployed on one physical device at the same time. And pods of different businesses are independent and do not interfere with each other. Therefore, it is necessary to ensure that resource usage is isolated from each other, ensure independent use of resources, and prevent other businesses from occupying resources. Once the resource isolation function fails, the scope of impact may expand to containers of other normal businesses, which is extremely harmful.

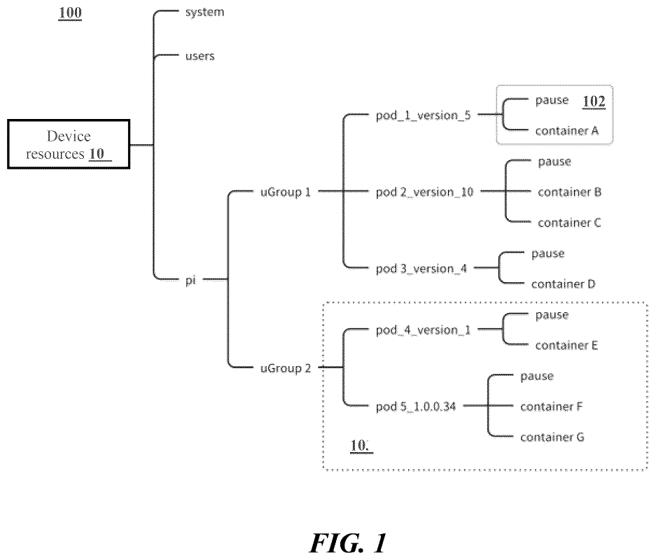

FIG. 1 shows a schematic diagram of a device resource hierarchy structure 100 according to one or more embodiments of the present disclosure. Alternatively, the device resource hierarchy structure 100 may be based on Linux control group hierarchy for resource allocation. In the resource hierarchy structure 100, the device resource 101 includes system(s), users and a resource scheduling platform pi. Alternatively, the resource scheduling platform pi may include a user group layer, and the user group layer may include one or more user groups. Exemplarily, the user group layer may include uGroup 1, uGroup 2, uGroup 3, . . . , uGroup n (for simplicity, only uGroup 1 and uGroup 2 are shown in FIG. 1). Alternatively, the user group may include a pod layer, and the pod layer may include one or more pods. Exemplarily, uGroup 1 may include pod_1_version_5, pod_2_version_10, pod_3_version_4 etc. Generally speaking, a pod is the smallest deployable computing unit that is created and managed. The unique identifier (ID) of a pod consists of its ID and version information. Pods with the same pod ID but different versions belong to the old and new pod units generated during the upgrade process.

Alternatively, the pod may include a container layer, and the container layer may include one or more containers. Block 102 shows the pod structure of pod_1_version_5, for example, pod_1_version_5 includes a pause container and another container A. Generally speaking, the container may be the smallest unit of resource division. The application and its dependencies are packaged into an independent unit for operation. It is the smallest unit of resource management. And one of the more special containers is the pause container, which is mainly used to provide a shared runtime environment and infrastructure-related functions such as network for other containers in the pod. The pause container does not occupy resources and occupies a position in the hierarchy structure 100, but may be ignored in resource management.

Alternatively, the user groups are specified by the business when a pod is created. And containers of a business party are deployed in the same user group, and user groups may be the smallest unit of resource isolation. Exemplarily, as shown at block 103, uGroup 2 may include pod_4_version_1, pod_5_version_1.0.0.34 etc., and pod_4_version_1 includes a pause container and container E, and pod_5_version_1.0.0.34 includes a pause container, container F and container G. Alternatively, pod_4_version_1 and pod_5_version_1.0.0.34 belong to uGroup 2, and pod_4_version_1 and pod_5_version_1.0.0.34 are both in a same business space. Thus, one or more embodiments of the present disclosure may provide a method, device or medium for sharing resource between pod_4_version_1 and pod_5_version_1.0.0.34 within uGroup 2. Alternatively, one or more embodiments of the present disclosure may provide a method, device or medium for isolating resource sharing among the user groups (e.g., uGroup 1 and uGroup 2 etc.).

Therefore, it can be seen that a method or system is needed to solve problems with resource sharing for multiple containers. The present disclosure proposes a method, device, system, medium, etc. for sharing resource. Exemplarily, the embodiments of the present disclosure develop the hierarchical structure 100 designed based on business attributes, and the hierarchical structure100 is abstracted into a tree structure, and business attributes are added to the hierarchical structure 100, which realizes resource isolation between user groups and resource sharing within user groups. Alternatively, the embodiments of the present disclosure also develop flexible resource management rules based on request/limit. That is, the scope of usage is restricted at the user group/pod/container level. When resources are scarce, they are allocated in proportion to the allocation situation. When resources are redundant, some resources can be shared.

More specifically, a method of the embodiments of the present disclosure may be provided for sharing resources. The method may determine resource requests for a plurality of containers. And the method may determine resource limits for the plurality of containers. Then the method further may share, based on the resource requests and the resource limits, the resources among at least a portion of the plurality of containers, wherein the at least a portion of the plurality of containers belongs to a same user.

In this way, by sharing, based on the resource requests and the resource limits, the resources among at least a portion of the plurality of containers, and the at least a portion of the plurality of containers belongs to a same user, the embodiments of the present disclosure realize resource sharing of the same business attributes on the same device, and ensure that multiple containers with the same business attributes share sufficient resources, and allocate them according to the configured resource specifications in scenarios where resources are not sufficient.

Next, multiple embodiments of the present disclosure will be described in detail with reference to the relevant drawings and based on the hierarchy structure 100 according to one or more embodiments of the present disclosure.

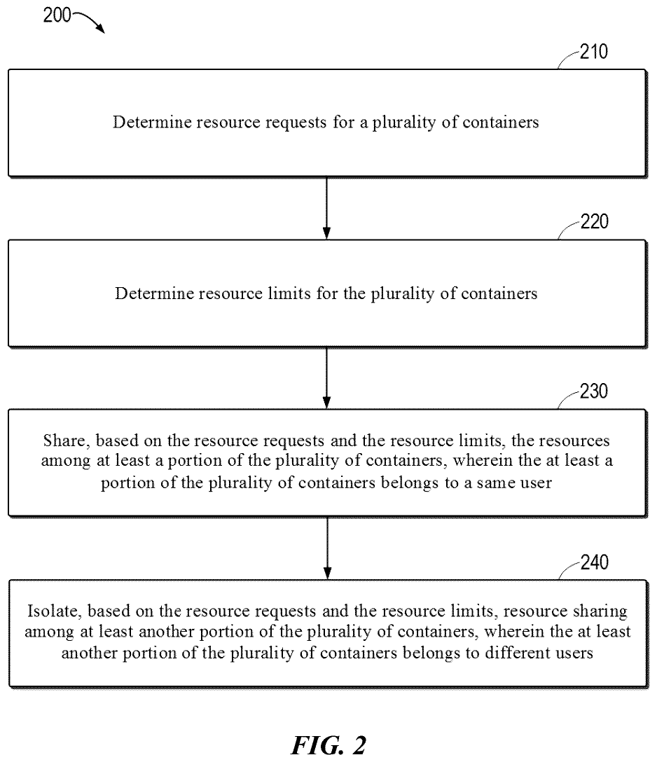

FIG. 2 is a flow chart illustrating an example process 200 of sharing resources according to some embodiments of the present disclosure. The example process 200 may be implemented by a computing device, and may be implemented on the resource scheduling platform pi of the hierarchy structure 100. The present disclosure does not specifically limit the specific implement of the process 200. Any suitable implement of process 200 for the present disclosure should be within the protection scope of the present disclosure. As shown in FIG. 2, at block 210, resource requests for a plurality of containers may be determined. Alternatively, the resource requests may be set as minimum resource requirements for container usage for the plurality of containers respectively. Alternatively, the resource requests for a plurality of containers may be obtained by reading a configure file from a user. The resource requests of the configure file may be taken as the original resource requests for a plurality of containers. Exemplarily, the original resource request for a container may be (3c, 2G), which means the container needs 3 CPU cores and 2G memory. It is worth noting that one or more embodiments of the present disclosure do not impose any restrictions on the form or number of resource requests and how to obtain what kind of resource requests. Any resource request suitable for the present disclosure are within the protection scope of the present disclosure. Alternatively, the resource requests may be adjusted based on the original resource requests according to the specific system resource conditions. Exemplarily, the values of the resource requests may be greater than the values of the original resource requests, as an example, if resources are sufficient, the resource request for the container may be (4c, 3G) based on the original resource request for a container being (3c, 2G). And at block 220, resource limits for the plurality of containers are determined. Alternatively, the resource limits may be set as maximum resource requirements for container usage for the plurality of containers respectively.

More specifically, one or more embodiments of the present disclosure implement resource management using two mechanisms of request and limit. Alternatively, as for the mechanisms of request, request may indicate the minimum resource requirement used by the container, and it is the basis for resource allocation during container scheduling. For CPU resources, requests. cpu may be set to cgroup cpu. shares in actual use as the relative weight of the container's CPU. Alternatively, when CPU resources are sufficient, requests. cpu may not limit usage, and when CPU resources are tight, the container may allocate available CPU resources in proportion to the relative weight. Alternatively, as for the memory resources, requests. memory has no corresponding Linux parameter and only acts as a conditional parameter during scheduling. Alternatively, the deployment process writes requests. memory to file storage, using a hierarchical structure similar to cgroup. The file is located at /resource/$uGroup/$pod_ID_version/memory_in_bytes

Alternatively, as for the mechanisms of limit, limit may indicate the maximum value of resources that a container can use. Alternatively, for CPU resources, limits.cpu may be converted into the Linux cgroup cpu.cfs_quota_us parameter to limit the maximum CPU usage of the container. Regardless of whether the device resources are sufficient or tight, the CPU usage of the container may not exceed this limit. Alternatively, in addition, limits. memory may be converted into the Linux cgroup memory_in_bytes parameter. When the memory usage of the container exceeds this limit, it may trigger Out of Memory (OOM) of the container and cause the container to exit.

Referring back to FIG. 2, at block 230, the resources may be shared among at least a portion of the plurality of containers based on the resource requests and the resource limits, and the at least a portion of the plurality of containers belongs to a same user. Alternatively, resources may be shared and allocated within the business space of the same user based on the request/limit mechanisms. Alternatively, when resources are sufficient, resources belonging to the same user can be allocated to containers that need more. This ensures that the resource requirements of each container of the same user are met and fully utilizes the resources requested by the user. Alternatively, when resources are not sufficient, resources belonging to the same user can be allocated to containers according to a configured resource specification.

At block 240, based on the resource requests and the resource limits, resource sharing among at least another portion of the plurality of containers is isolated, wherein the at least another portion of the plurality of containers belongs to different users. Alternatively, the process 200 may further determine a resource hierarchy, wherein the resource hierarchy includes user groups, and the user group includes one or more pods, and the pod includes one or more containers. Alternatively, the process 200 may further share the resource within the user groups, and isolate resource sharing among the user groups. Alternatively, the process 100 may further isolate resource sharing among the user groups based on the resource requests and the resource limits.

In this way, by sharing, based on the resource requests and the resource limits, the resources among at least a portion of the plurality of containers, and the at least a portion of the plurality of containers belongs to a same user, the embodiments of the present disclosure realize resource sharing of the same business attributes on the same device, and ensure that multiple containers with the same business attributes share sufficient resources, and allocate them according to the configured resource specifications in scenarios where resources are not sufficient.

As mentioned above, managing pods on physical devices refers to the automatic deployment, scaling, and management of containerized applications on physical machines. In order to optimize resource utilization, resource allocation rules and management on physical devices face huge challenges.

On the other hand, there are also problems with dynamic resource adjustment. That is, as the running status of the containerized application pod changes, the resources of the pod need to be dynamically adjusted, that is, the CPU (specifically the CPU resources of the pod) and memory quota of the pod need to be adjusted without affecting the running status of the pod.

In addition, there are also difficulties in flexible resource configuration. That is, considering the sudden resource usage scenarios caused by sudden traffic that may be encountered by the business, it is necessary to support flexible container resource restriction methods. Compared with fixed resource usage quotas, it is necessary to configure a usage range for resource usage and distinguish between situations where resources are sufficient and those that are insufficient for targeted treatment.

One of the existing resource isolation/sharing management technical solutions is to support the use of namespaces in Kubernetes to achieve resource isolation and dynamically adjust the resources requested by pods. Its drawback is that it does not support pods belonging to the same namespace to share resources. In addition, resource isolation/namespaces provide a mechanism to divide resources in the same cluster into isolated groups. Resource names must be unique within a namespace, but cannot cross namespaces. Namespaces cannot be nested with each other, and each Kubernetes resource can only be in one namespace. Another drawback is that in Kubernetes, physical devices are the smallest unit of the cluster, and the resource division of physical machines uses containers as the smallest unit of isolation. Since business attributes are not introduced as the division criteria for namespaces, it is impossible to implement isolation and sharing strategies for business attributes on the same device.

In addition, Kubernetes supports vertical scaling of pods. Nodes allocate resources to pods based on pod requests and limit pod resource usage based on the limits specified in the pod's container. The drawback is that Kubernetes does not support resource sharing for all pods in the same namespace, so it does not handle the situation where the resource specifications of the entire namespace change when adjusting the resource specifications of a single pod. In addition, if there is a shortage of resources during the expansion operation, Kubernetes may destroy the current container and select a new node to rebuild the container, which can easily cause service stability issues in the business.

To solve at least one of the above problems, the present disclosure provides a method, electronic device, system and medium for supporting hierarchical resource isolation and sharing of dynamically adjusted tenant groups. And one or more embodiments of the present disclosure further develop multiple mechanisms. First, one or more embodiments of the present disclosure provide flexible resource management rules based on request/limit, that is, the scope of use is restricted at the user group/pod/container level, and resources are allocated proportionally when resources are tight, and certain resources are allowed to be shared when resources are redundant. And one or more embodiments of the present disclosure further provide an implementation method for dynamically adjusting container resources, that is, adjusting the resource usage quota of the container more safely without affecting the normal operation of the container. In addition, one or more embodiments of the present disclosure also provide a calculation method for container resources at different levels, that is, through different request and limit calculation methods at the pod layer and the user group layer, resource sharing and isolation are realized.

Through the above one or more mechanisms, one or more embodiments of the present disclosure can realize resource sharing with the same business attributes on the same device, that is, to ensure that multiple pods with the same business attributes share redundant resources, and at the same time, in the scenario of tight resources, allocate according to the configured resource specifications. Moreover, one or more embodiments of the present disclosure can also realize resource isolation of different business attributes on the same device, that is, ensure that multiple pods with different business attributes do not interfere with each other when deployed on the same device, and realize strict isolation of resources. In addition, one or more embodiments of the present disclosure can also realize dynamic adjustment of container resources, that is, adjust the resource specifications of the container without affecting the running status of the pod. In addition, one or more embodiments of the present disclosure can also reduce the impact of resource overselling problems caused by smooth upgrades, that is, ensure that the resource occupation of pods during smooth upgrades may not affect the normal operation of pods of other user groups, and ensure that the scope of impact of resource overselling caused by smooth upgrades is controlled within the user groups within the business. The following will describe in detail multiple embodiments of the present disclosure in conjunction with relevant drawings.

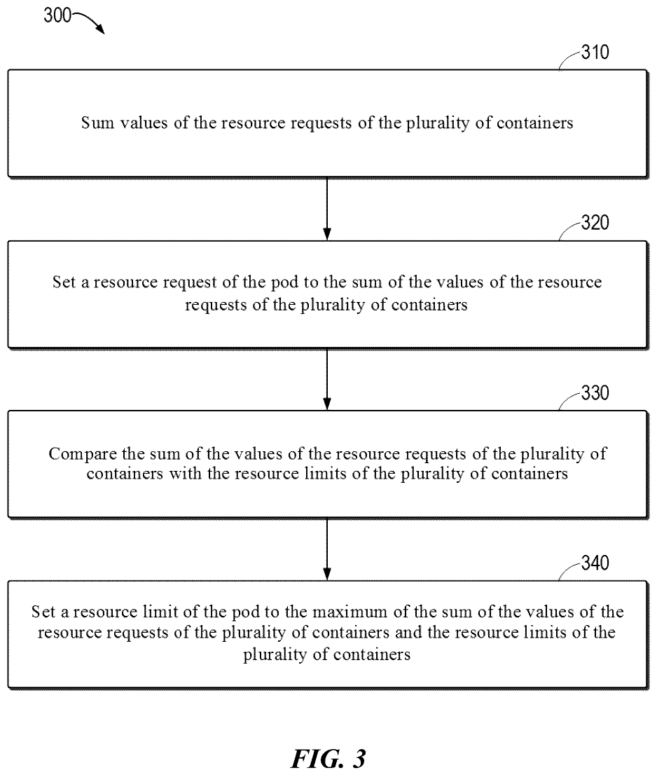

FIG. 3 is a flow chart illustrating an example process 300 of determining pod requests/limit according to some embodiments of the present disclosure. Alternatively, pod is implemented based on the Linux cgroup resource control method. At block 310, for the plurality of containers belonging to a same pod, values of the resource requests of the plurality of containers are summed. And at block 320, a resource request of the pod may be set to the sum of the values of the resource requests of the plurality of containers. And at block 330, the sum of the values of the resource requests of the plurality of containers is compared with the resource limits of the plurality of containers.

Then, at block 340, a resource limit of the pod may be set to the maximum of the values of the sum of the values of the resource requests of the plurality of containers and the resource limits of the plurality of containers. Alternatively, in response to resource tension and based on the total resources requested by each container in the same pod, the total resources may be allocated to each container in equal proportion to the resources requested by each container. Alternatively, in response to sufficient resources, the resource limit of a container in the pod may be permitted to be greater than the resource limit of the pod. As for how to determine the request/limit of a pod, one or more embodiments of the present disclosure may describe in more detail later.

More specifically, as an example, the request/limit of a pod may be calculated using equations 1 and 2:

$$pod . request = sum ( [ ] container . request ) \qquad ( 1 )$$

$$pod . limit = max ( sum ( [ ] container . request ) , container\_i . limit ) \qquad ( 2 )$$

wherein, pod. request is the source request of a pod, and pod. limit is the source limit of the pod, and []container. request means all source requests of the containers of the pod. And container_i. limit is the source limit of container i.

More specifically, pod. request is equal to the sum of resources requested by all containers that make up the pod. When resources are not sufficient, priority is given to allocating resources in equal proportion to the sum of resources requested by the pods. Containers in the same pod are allocated in equal proportion to the resources requested by each container.

In addition, pod. limit is the maximum value of pod. request and each container limit value. Generally, the pod. request value is greater than the resource. limit of a single container. However, when the resource limit value of a container is greater than pod. request, it means that the container may use more resource quotas than the same pod. That is, when resources are sufficient, it is allowed to preempt resources from different pods belonging to a same user.

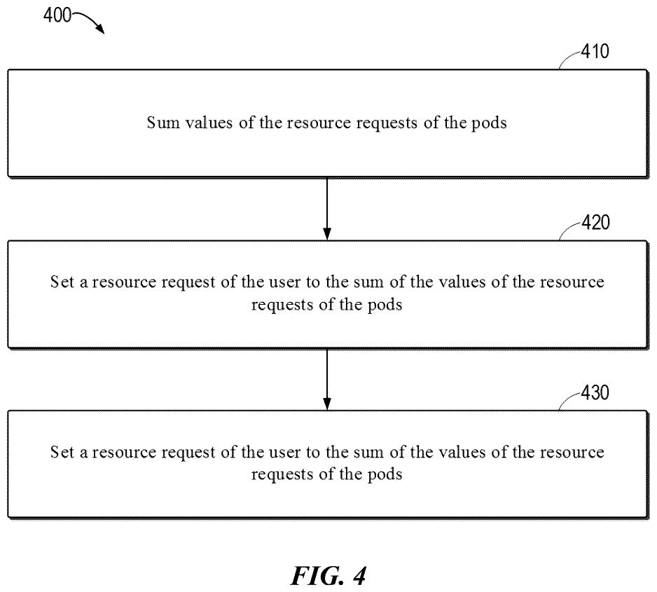

FIG. 4 is a flow chart illustrating an example process 400 of determining request/limit of a user group according to some embodiments of the present disclosure. Alternatively, user group may also be implemented based on the Linux cgroup resource control method. At block 410, values of the resource requests of the pods may be summed. And at block 420, a resource request of the user may be set to the sum of the values of the resource requests of the pods. And at block 430, a resource limit of the user may be set to the sum of the values of the resource requests of the pods. Alternatively, in response to resource tension and based on the total resources requested by each pod belonging to the same user, the total resources may be allocated to each pod in equal proportion to the resources requested by each pod. Alternatively, in response to sufficient resources, the resource limit of the same user may be kept being equal to the resource request of the same user continuously. As for how to determine the request/limit of a user group, one or more embodiments of the present disclosure may describe in more detail later.

More specifically, as an example, the request/limit of a user group may be calculated using equations 3 and 4:

$$uGroup . request = sum ( [ ] pod . request ) \qquad ( 3 )$$

$$uGroup . limit = sum ( [ ] pod . request ) \qquad ( 4 )$$

wherein, the uGroup. request is the resource request of a user group, and []pod. request means all the resource requests of the pods belonging to the user group, uGroup. limit is the resource limit of the user group.

More specifically, uGroup. request may be equal to the sum of resources requested by all pods belonging to the user group. When resources are not sufficient, priority is given to proportional allocation based on the total amount of resources requested by user groups. Pods in the same user group are allocated proportionally based on the resources requested by each pod. In addition, pod. limit is equal to pod. request. Since pod. limit is equal to pod. request, it means that no pod under the user group can use resources that exceed the total amount of resources requested by the user group, that is, when resources are sufficient, it is not allowed to preempt resources from different user groups. Under such a mechanism in one or more embodiments of the present disclosure, the present disclosure realizes resource sharing within the same user group, while resources in different user groups are strictly isolated and encroachment is not allowed.

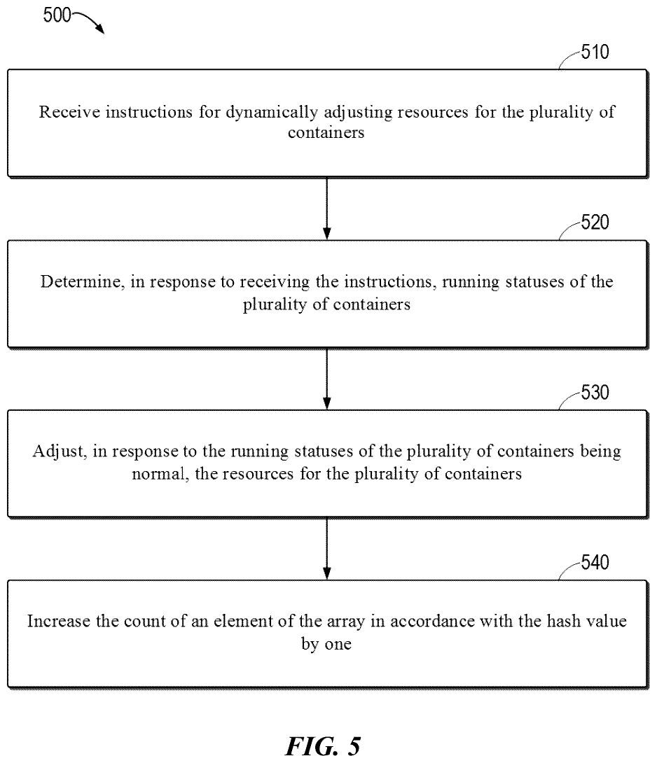

FIG. 5 is a flow chart illustrating an example process 500 of dynamically adjusting container allocation resources according to some embodiments of the present disclosure. At block 510, instructions for dynamically adjusting resources for the plurality of containers may be received. Alternatively, the instructions for dynamically adjusting resources for the plurality of containers may be initiated by the resource scheduling platform pi. Alternatively, the instruction may be sent by high level device resources 101. And at block 520, in response to receiving the instructions, running statuses of the plurality of containers may be determined. Alternatively, only the container with normal running status can be the candidate for adjusting. Alternatively, the normal running status may include no OOM, no other serious system running errors etc.

Then at block 530, in response to the running statuses of the plurality of containers being normal, the resources for the plurality of containers may be adjusted. Alternatively, in response to the instructions being downscaling operation, resource usage of the plurality of containers may be determined. Alternatively, in response to the resource usage of the plurality of containers being less than a predetermined threshold, the resource usage of the plurality of containers may be limited. Alternatively, the predetermined threshold may be 80%. It is worth noting that one or more embodiments of the present disclosure do not impose any restrictions on the predetermined threshold. Any predetermined threshold suitable for the present disclosure are within the protection scope of the present disclosure. Alternatively, in response to the resource usage of the container being less than the predetermined threshold, target resource values of the plurality of containers, the pods and the user groups may be determined in the order of the plurality of containers, pods and user groups, respectively, and the resource usage of user groups, pods and containers may be limited based on the target resource values of the plurality of containers, the pods and the user groups. Alternatively, in response to the running statuses of the plurality of containers being normal and the instructions being downscaling operation, resource usage of the plurality of containers may be determined. Alternatively, in response to the resource usage of the plurality of containers being greater than the predetermined threshold, limiting the resource usage of the plurality of containers may be refused.

Still at block 530, Alternatively, in response to the running statuses of the plurality of containers being normal and the instructions being scaling operation and in the order of user groups, pods and the plurality of containers, target resource values of the user groups, the pods and the plurality of containers may be determined respectively. Alternatively, based on the target resource values of the user groups, the pods and the plurality of containers, the resource usage of user groups, pods and containers may be increased.

More specifically, after receiving the command to limit the dynamic adjustment of container resources, the resource scheduling platform pi may perform related operations in sequence. First, the resource scheduling platform pi may check the operation status of the container and only adjust the containers that are running normally. For the scenario of downscaling operation, the resource scheduling platform pi may check whether the resource usage of the current container is greater than the predetermined threshold (e.g., 80%). If the current usage rate exceeds the predetermined threshold, the downscaling operation may not be performed to prevent the downscaling operation from directly causing the containers to switch from the running state to the set state. If it is a scaling operation, the target value corresponding to each layer is calculated and adjusted from the user group layer to the pod layer, and then from the pod layer to the container layer. On the contrary, for the downscaling operation, it is adjusted step by step from the container layer to the pod layer, and then from the pod layer to the user group layer.

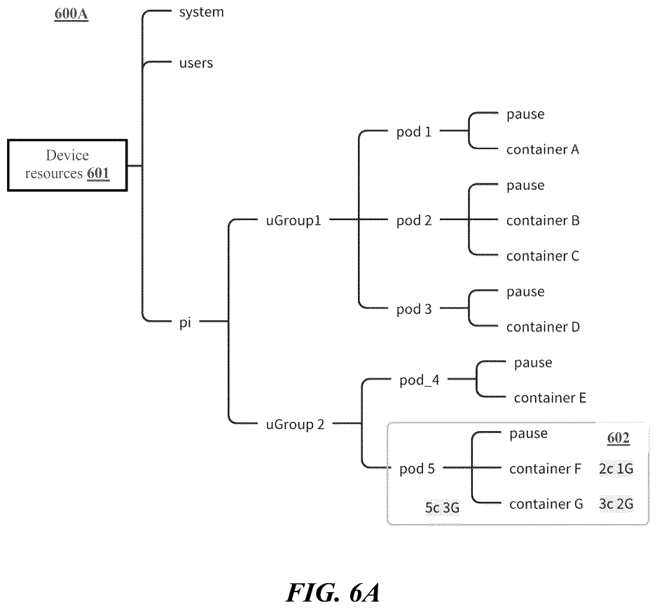

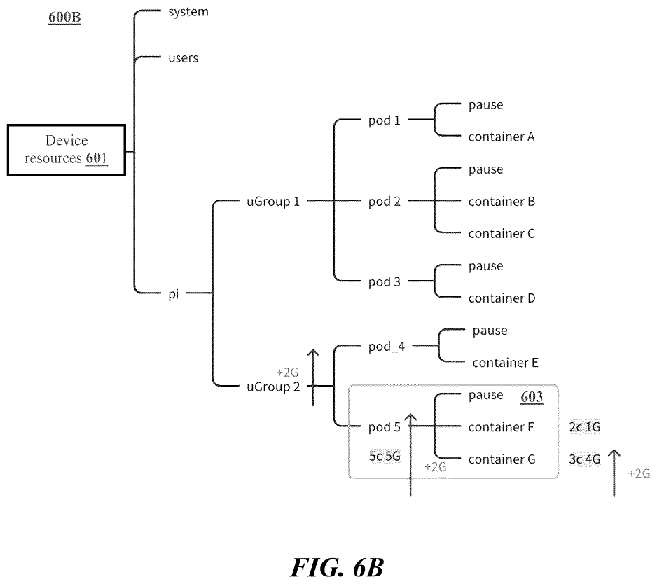

Exemplarily, FIGS. 6A and 6B are schematic diagrams of dynamically adjusting container resource allocation in a scaling operation scenario according to some embodiments of the present disclosure. FIG. 6A shows the device resource hierarchy structure 600A before the scaling operation, and FIG. 6B shows the device resource hierarchy structure 600B after the scaling operation based on the hierarchy structure 600A. Alternatively, the device resource hierarchy structure 600A may be based on Linux control group hierarchy for resource allocation. In the resource hierarchy structure 600A, the device resources 601 include system(s), users and a resource scheduling platform pi. Alternatively, the resource scheduling platform pi may include a user group layer, and the user group layer may include one or more user groups. Exemplarily, the user group layer may include uGroup 1, uGroup 2, uGroup 3, . . . , uGroup n (for simplicity, only uGroup 1 and uGroup 2 are shown in FIG. 6A.). Alternatively, the user group may include a pod layer, and the pod layer may include one or more pods. Exemplarily, uGroup 1 may include pod 1, pod 2 and pod 3 etc. Generally speaking, a pod is the smallest deployable computing unit that is created and managed. The unique identifier (ID) of a pod consists of its ID.

Alternatively, the pod may include a container layer, and the container layer may include one or more containers. Block 602 shows the pod structure of pod 5, for example, pod 5 includes a pause container, container F and container G. Generally speaking, the container may be the smallest unit of resource division. The application and its dependencies are packaged into an independent unit for operation. It is the smallest unit of resource management. And one of the more special containers is the pause container, which is mainly used to provide a shared runtime environment and infrastructure-related functions such as network for other containers in the pod. The pause container does not occupy resources and occupies a position in the hierarchy structure 600A, but may be ignored in resource management. Exemplarily, the source request of pod 5 may be (5c, 3G), which means pod 5 needs 5 CPU cores and 3G memory. And the source request of container F may be (2c, 1G), which means container F needs 2 CPU cores and 1G memory. And the source request of container G may be (3c, 2G), which means container G needs 3 CPU cores and 2G memory. It is worth noting that one or more embodiments of the present disclosure do not impose any restrictions on the form or number of resource requests and how to obtain what kind of resource requests. Any resource request suitable for the present disclosure are within the protection scope of the present disclosure.

Furthermore, FIG. 6B shows the process of dynamically adjusting container resource allocation in a scaling operation scenario and the device resource hierarchy structure 600B after the scaling operation based on the hierarchy structure 600A. Alternatively, the scaling operation may be a vertical scaling operation. The hierarchy structure 600B includes the device resources 601. Considering that the hierarchical structure 600B is based on the hierarchical structure 600A and the hierarchical structure 600A has been introduced in detail above, in order to save space, all components of the hierarchical structure 600B will not be introduced in detail here. When receiving the instructions of scaling operation, the resource scheduling platform pi may increase a target resource value of uGroup 2 by 2G for memory, firstly. Then, at block 603, the resource scheduling platform pi may also increase a target resource value of pod 5 by 2G for memory, and then the resource scheduling platform pi may also increase a target resource value of container G by 2G for memory, finally.

In this way, by using the methods for dynamically adjusting container resources according to one or more embodiments of the present disclosure, it is ensured that the resource usage quota of the container is adjusted more safely without affecting the normal operation of the container.

To sum up, one or more embodiments of the present disclosure provide a method, electronic device, system and medium for supporting hierarchical resource isolation and sharing of dynamically adjusted user groups. And the present disclosure provides multiple mechanisms through the above one or more embodiments. First, one or more embodiments of the present disclosure are based on a resource management hierarchical structure designed based on business attributes, by abstracting the resource management structure into a tree structure, and adding business attributes to the hierarchical structure, so as to achieve resource isolation between user groups and resource sharing within user groups. In addition, one or more embodiments of the present disclosure are based on the flexible resource management rules of request/limit, and the scope of use is restricted at the user group/pod/container layer. When resources are not sufficient, they are allocated proportionally according to the allocation situation, and certain resources are allowed to be shared when resources are sufficient. And one or more embodiments of the present disclosure adopt an implementation method of dynamically adjusting container resources, which adjusts the resource usage quota of the container more safely without affecting the normal operation of the container. In addition, one or more embodiments of the present disclosure also adopt a calculation method of container resources at different levels, and realizes resource sharing and isolation through different request and limit calculation methods at the pod layer and the user group layer.

Therefore, one or more embodiments of the present disclosure have achieved significant technical effects through the above mechanisms. As an example, one or more embodiments of the present disclosure implement strict isolation of resources in different business spaces and improve the stability of business operation. In addition, one or more embodiments of the present disclosure support the deployment of services of different business parties on the same device, and provide a deployment environment in which resources are strictly isolated and do not interfere with each other for multiple services. In addition, one or more embodiments of the present disclosure provide the basic conditions for multiple business parties to run on the same device, and effectively guarantee the stable operation of the business, and provide stable and reliable services. In addition, one or more embodiments of the present disclosure adopt a flexible resource restriction method to support business burst traffic, and one or more embodiments of the present disclosure set a range value for resource usage, so as to effectively distinguish between scenarios of sufficient resources and resource tension, and provide basic capabilities for dealing with burst traffic while providing stable operation guarantees for the business. In addition, it helps the business parties to use resources effectively, fully release the growth potential of the business, and increase revenue. In addition, one or more embodiments of the present disclosure can adjust the deployment strategy according to the specific situation of the resources, and the business can flexibly adjust the resource quota according to the actual resource usage. Without affecting the guarantee of normal business services, the resource quota of the vertical expansion service may be observed when the resources are sufficient to better respond to large-scale requests. When resources are insufficient, the resource quota of the service can be vertically reduced to reduce unnecessary idle resources, thereby obtaining an optimized deployment strategy while ensuring business stability.

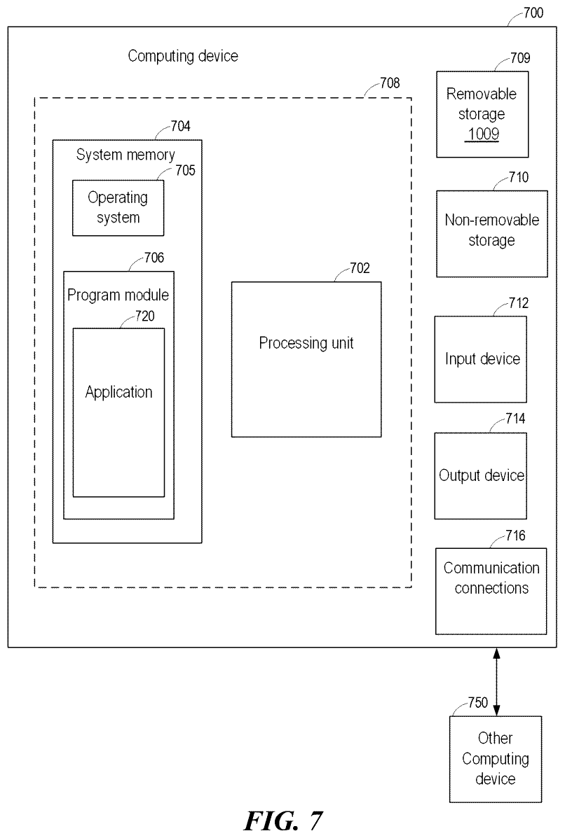

FIG. 7 is a block diagram illustrating physical components (e.g., hardware) of an electronic device 700 with which aspects of the disclosure may be practiced. For example, the electronic device 700 may implements the processes as depicted in FIGS. 2-5. In a basic configuration, the processing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the processing device 700. Furthermore, aspects of the disclosure may be practiced in conjunction with other operating systems, or any other application program and is not limited to any particular application or system. This basic configuration is illustrated in FIG. 7 by those components within a dashed line 708. The processing device 700 may have additional features or functionality. For example, the processing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, an application 720 or program modules 706 may perform processes including, but not limited to, one or more aspects, as described herein. The application 720 may include an application interface 721 which may be the same as or similar to the application interface 721 as previously described in more detail with regard to FIG. s 2-5. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The processing device 500 may include one or more communication connections allowing communications with other computing or processing devices 750. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 700. Any such computer storage media may be part of the processing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for sharing resources, comprising:
determining resource requests for a plurality of containers;
determining resource limits for the plurality of containers;
sharing, based on the resource requests and the resource limits, the resources among at least a portion of the plurality of containers, wherein the at least a portion of the plurality of containers belongs to a same user; and
isolating, based on the resource requests and the resource limits, resource sharing among at least another portion of the plurality of containers, wherein the at least another portion of the plurality of containers belongs to different users.

2. The method according to claim 1, the method further comprising:
setting the resource requests as minimum resource requirements for container usage for the plurality of containers respectively; and
setting the resource limits as maximum resource requirements for container usage for the plurality of containers respectively.

3. The method according to claim 2, wherein for the plurality of containers belonging to a same pod, determining resource requests for the plurality of containers comprises:
summing values of the resource requests of the plurality of containers; and
setting a resource request of the pod to the sum of the values of the resource requests of the plurality of containers.

4. The method according to claim 3, wherein determining resource limits for the plurality of containers:
comparing the sum of the values of the resource requests of the plurality of containers with the resource limits of the plurality of containers; and
setting a resource limit of the pod to the maximum of the sum of the values of the resource requests of the plurality of containers and the resource limits of the plurality of containers.

5. The method according to claim 4, the method further comprising:
allocating, in response to resource tension and based on the total resources requested by each container in the same pod, the total resources to each container in equal proportion to the resources requested by each container.

6. The method according to claim 4, wherein sharing, based on the resource requests and the resource limits, the resource among at least a portion of the plurality of containers comprises:
permitting, in response to sufficient resources, the resource limit of a container in the pod being greater than the resource limit of the pod.

7. The method according to claim 4, wherein for pods belonging to the same user, determining resource requests for the plurality of containers comprises:
summing values of the resource requests of the pods; and
setting a resource request of the user to the sum of the values of the resource requests of the pods.

8. The method according to claim 7, wherein determining resource limits for the plurality of containers:
setting a resource limits of the user to the sum of the values of the resource requests of the pods.

9. The method according to claim 8, the method further comprising:
allocating, in response to resource tension and based on the total resources requested by each pod belonging to the same user, the total resources to each pod in equal proportion to the resources requested by each pod.

10. The method according to claim 8, wherein isolating, based on the resource requests and the resource limits, resource sharing among at least another portion of the plurality of containers comprises:
keeping, in response to sufficient resources, the resource limit of the same user being equal to the resource request of the same user continuously.

11. The method according to claim 1, the method further comprising:
receiving instructions for dynamically adjusting resources for the plurality of containers;
determining, in response to receiving the instructions, running statuses of the plurality of containers; and
adjusting, in response to the running statuses of the plurality of containers being normal, the resources for the plurality of containers.

12. The method according to claim 11, wherein adjusting, in response to the running statuses of the plurality of containers being normal, the resources for the plurality of containers comprises:
determining, in response to the instructions being downscaling operation, resource usage of the plurality of containers;
limiting, in response to the resource usage of the plurality of containers being less than the predetermined threshold, the resource usage of the plurality of containers.

13. The method according to claim 12, wherein limiting, in response to the resource usage of the container being less than the predetermined threshold, the resource usage of the container comprises:
determining, in the order of the plurality of containers, pods and user groups, target resource values of the plurality of containers, the pods and the user groups respectively; and
limiting, based on the target resource values of the plurality of containers, the pods and the user groups, the resource usage of user groups, pods and the plurality of containers.

14. The method according to claim 11, wherein adjusting, in response to the running statuses of the plurality of containers being normal, the resources for the plurality of containers further comprises:
determining, in response to the instructions being downscaling operation, resource usage of the plurality of containers; and
refusing, in response to the resource usage of the plurality of containers being greater than a predetermined threshold, limiting the resource usage of the plurality of containers.

15. The method according to claim 11, wherein adjusting, in response to the running statuses of the plurality of containers being normal, the resources for the plurality of containers comprises:
determining, in response to the instructions being scaling operation and in the order of user groups, pods and the plurality of containers, target resource values of the user groups, the pods and the plurality of containers respectively; and
increasing, based on the target resource values of the user groups, the pods and the plurality of containers, the resource usage of user groups, pods and the plurality of containers.

16. The method according to claim 1, the method further comprising:
determining a resource hierarchy, wherein the resource hierarchy includes user groups, and the user group includes one or more pods, and the pod includes one or more containers.

17. The method according to claim 16, wherein isolating, based on the resource requests and the resource limits, resource sharing among at least another portion of the plurality of containers comprises:
isolating, based on the resource requests and the resource limits, resource sharing among the user groups.

18. An electronic device, comprising:
a memory and a processor;
wherein the memory is configured to store one or more computer instructions which, when executed by the processor, cause the processor to:
determine resource requests for a plurality of containers;
determine resource limits for the plurality of containers;
share, based on the resource requests and the resource limits, the resources among at least a portion of the plurality of containers, wherein the at least a portion of the plurality of containers belong to a same user; and
isolate, based on the resource requests and the resource limits, resource sharing among at least another portion of the plurality of containers, wherein the at least another portion of the plurality of containers belongs to different users.

19. The device according to claim 18, wherein the one or more computer instructions further cause the processor to:
set the resource requests as minimum resource requirements for container usage for the plurality of containers respectively; and
set the resource limits as maximum resource requirements for container usage for the plurality of containers respectively.

20. A non-transitory computer-readable medium comprising instructions stored thereon which, when executed by a processor, cause the processor to:
determine resource requests for a plurality of containers;
determine resource limits for the plurality of containers;
share, based on the resource requests and the resource limits, the resources among at least a portion of the plurality of containers, wherein the at least a portion of the plurality of containers belongs to a same user; and
isolate, based on the resource requests and the resource limits, resource sharing among at least another portion of the plurality of containers, wherein the at least another portion of the plurality of containers belongs to different users.
